(19) United States
(12) Patent Application Publication
(10) Pub. No.: US 2025/0182181 A1
(43) Pub. Date: Jun. 5, 2025

(54) GENERATING PRODUCT PROFILE RECOMMENDATIONS AND QUALITY INDICATORS TO ENHANCE PRODUCT PROFILES

(71) Applicant: Adobe Inc., San Jose, CA (US)

(72) Inventor: Soumya UNNIKRISHNAN, Austin, TX (US)

(21) Appl. No.: 18/529,757

(22) Filed: Dec. 5, 2023

(51) Int. Cl. G06Q 30/0601

(52) U.S. Cl. CPC G06Q 30/0631

(57) ABSTRACT

Methods, computer systems, and computer-storage media are provided for efficiently generating product profile recommendations, among other things. In embodiments, catalog content and customer content associated with a product type of a product is obtained. Thereafter, candidate attributes for the product are identified from the catalog and customer content associated with the product type. A model prompt is generated to be input into a large language model. The model prompt includes the candidate attributes, or a portion thereof, a product profile associated with the product, and an instruction to generate a recommendation for a new attribute to associate with the product based on the product profile and the candidate attributes. An attribute recommendation is generated, via the large language model, that recommends the new attribute to include in the product profile. Such an attribute recommendation is provided as a recommendation to include in the product profile associated with the product.

### BACKGROUND

E-commerce platforms generally use product profiles to facilitate a better user experience and to improve marketing efforts, among other things. Oftentimes, however, product profiles do not provide complete product information. For example, a product profile may have an incomplete list of attributes, descriptions, and details associated with a product. Given the evolution of catalogs on e-commerce websites due to new inventory, product updates, and changing consumer interactions with products, product profiles are often outdated or undesirable to a consumer.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various aspects of the technology described herein are generally directed to systems, methods, and computer storage media for, among other things, efficient and effective enhancement of product profiles. In particular, product profile recommendations and/or product profile quality indicators are efficiently and effectively generated in an automated manner such that the product profile can be enhanced in an effective manner. In this regard, embodiments described herein provide formative feedback for product profiles though personalized and adaptive product profile recommendations and quality indicators indicating quality of the product profiles, or portions thereof. Advantageously, the product profile recommendations and/or quality indicators are adapted to consumer characteristics and interests, thereby resulting in more desired product profiles. Using such product profile recommendations and/or product profile quality indicators facilitates more suitable product profiles, thereby enhancing the value of the product profiles to consumers.

### BRIEF DESCRIPTION OF THE DRAWINGS

The technology described herein is described in detail below with reference to the attached drawing figures, wherein:

FIG. 1 is a block diagram of an exemplary system for facilitating efficient generation of product profile recommendations and product profile quality indicators, suitable for use in implementing aspects of the technology described herein;

FIG. 2 is an example implementation for facilitating efficient generation of product profile recommendations and product profile quality indicators, in accordance with aspects of the technology described herein;

FIG. 3 provides an example implementation for facilitating efficient generation of product profile attributes and product profile quality indicators, in accordance with embodiments of the present technology;

FIG. 4 provides an example implementation for facilitating fine-tuning a large language model using consumer feedback, in accordance with embodiments of the present technology;

FIG. 5 provides an example method for generating and using product profile recommendations, in accordance with embodiments of the present technology;

FIG. 6 provides an example method for generating product profile recommendations and product profile quality indicators, in accordance with aspects of the technology described herein;

FIG. 7 provides an example method for generating various product profile recommendations, in accordance with aspects of the technology described herein; and

FIG. 8 is a block diagram of an exemplary computing environment suitable for use in implementing aspects of the technology described herein.

### DETAILED DESCRIPTION

The technology described herein is described with specificity to meet statutory requirements. However, the description itself is not intended to limit the scope of this patent. Rather, the inventor has contemplated that the claimed subject matter might also be embodied in other ways, to include different steps or combinations of steps similar to the ones described in this document, in conjunction with other present or future technologies. Moreover, although the terms “step” and “block” may be used herein to connote different elements of methods employed, the terms should not be interpreted as implying any particular order among or between various steps herein disclosed unless and except when the order of individual steps is explicitly described.

### Overview

Product profiles on e-commerce platforms generally include natural language text describing products. Oftentimes, sellers of products do not provide complete product information in product profiles. For example, a product profile may have an incomplete list of attributes, description, and details associated with a product. Given the evolution of catalogs on e-commerce websites due to new inventory, product updates, and changing consumer interactions with products, product profiles are often outdated or undesirable to a consumer. Accordingly, to maintain or gain consumer interest in products, it is desirable to closely monitor the quality of the product profiles to ensure the product profiles capture the interest of consumers.

In conventional approaches, human auditing of product profiles is generally performed to identify incomplete and/or inaccurate aspects in product profiles. To do so, an individual, such as a merchandizer, must access a product profile and review the product profile. In some cases, the merchandizer must further perform research to understand aspects appropriate to provide a higher quality or more accurate product profile. Not only is such analysis time-consuming and inaccurate, computing resources are also unnecessarily consumed to manage the product profiles (e.g., accessing product profiles and using resources to identify aspects to modify/update). Moreover, given the scale of e-commerce catalogs, identifying incomplete and inaccurate product profiles often results in an extensive monitoring and analysis process.

Further, to the extent that product profiles do not accurately or fully represent products, consumers unnecessarily utilize computing resources to identify products of interest. For instance, consumers may generate and execute numerous search queries or access various product profiles to view products of interest, thereby consuming computing and network resources. For instance, computer input/output operations are unnecessarily increased in order for a consumer to identify a product when the product profile inadequately represents a product. As one example, each time a search query is performed to identify a product with a specific attribute that a consumer is searching, the information of the search query must be located at a particular computer storage address of a storage device. The information must then be retrieved from the particular computer storage address of the storage device and presented to the consumer. The consumer must review the results of the search query to determine whether the search results reflect the desired product. As the consumer must perform multiple search queries when the product profile information is inaccurate, computing resources are unnecessarily used to repeat the process for multiple iterations in order to submit new and/or different search queries, along with the subsequent accessing, presentation, and review process of the product profiles.

Accordingly, embodiments of the present technology are directed to efficient and effective enhancement of product profiles. In this regard, product profile recommendations and/or product profile quality indicators are efficiently and effectively generated in an automated manner such that the product profile can be enhanced in an effective manner. Embodiments described herein provide formative feedback for product profiles though personalized and adaptive product profile recommendations and quality indicators indicating quality of the product profiles, or portions thereof. Advantageously, the product profile recommendations and/or quality indicators are adapted to consumer characteristics and interests, thereby resulting in more desired product profiles. Using such product profile recommendations and/or product profile quality indicators facilitates more suitable product profiles, thereby enhancing the value of the product profiles to consumers. For example, adapting product profiles to changing consumer characteristics and/or desires can significantly improve consumer trust, product discoverability, and conversions, among other things.

In operation, to efficiently and effectively generate product profile recommendations, various content is used to extract candidate features, such as attributes, that are possible recommendations. In this way, catalog content and consumer content can be used to extract candidate features. Using catalog content and consumer content enables identification of product profile refinement opportunities that ensure accurately represented information as well as consumer-guided information. Generally, the catalog content and consumer content used to identify candidate features includes content corresponding to a particular product type that matches the product type of the product profile for which recommendations are being generated. Using content associated with a particular product type facilitates identifying more relevant candidate attributes as well as generating product profile recommendations in a more efficient manner. The candidate features, such as candidate attributes, are used to generate a product-type context. In some cases, relevance weights, scores, or ranks associated with the candidate attributes are also included in the product-type context. Such relevance scores can be used to filter and/or prioritize the data. The product-type context and the product profile are included in a model prompt that is used as input into a generative model, such as an LLM. The generative model generates a product profile recommendation, such as an attribute recommendation, for the product profile in the model prompt given the product-type context. In some cases, the generative model is fine-tuned with a dataset of product type and attribute pairs. Such fine-tuning provides a more industry-specific model, thereby enabling more accurate outputs, or recommendations. The product profile recommendation can be provided for display to a user, such as a merchandizer associated with the product for the product profile.

To generate a quality indicator for the product profile, or a portion thereof, in some cases, the product profile recommendation (e.g., attribute recommendation) is compared to the existing product profile (e.g., existing attributes in the product profile). In embodiments, a model-based text evaluation for entropy is used to perform such a comparison and generate a quality indicator. Additionally or alternatively, rule-based analysis can be performed to generate a quality indicator. Such rules can be provided, for example, by a merchandizer for analyzing corresponding product profiles. The quality indicator(s) can be provided for display to a user, such as a merchandizer associated with the product for the product profile.

Accordingly, based on the product profile recommendation and/or product profile quality indicator, a user, such as a merchandizer, can update or enhance the product profile. For example, a product profile recommendation recommending a new attribute(s) to supplement the product profile may be selected and added to the product profile, thereby increasing the quality of the product profile. Further, as discussed herein, in accordance with publishing a product profile, consumer feedback (e.g., clicks, selections, views, conversions, etc.) can be collected and used to fine-tune the generative model that generates product profile recommendations.

Generating product profile recommendations and/or product profile quality indicators in an automated manner reduces computing resources otherwise utilized to manually analyze and review product profiles. For example, content does not need to be downloaded and viewed to identify particular information about the product in order to manually update a product profile such that the product profile, or portion thereof, is relevant to consumers. As another example, computing resources used by a consumer to manually locate and review desired content are not needed. For instance, assume a user is generally interested in a particular product. Using embodiments described herein, a relevant and comprehensive product profile can be presented and/or searched on such that the consumer does not need to search to identify more relevant or engaging information. In this way, a consumer is presented with an accurate product profile, thereby reducing the additional computing resources consumed with a user otherwise searching for such information (e.g., by performing a search).

Further, various embodiments take significantly less quantity of time to train and deploy in a production environment because the various embodiments can utilize a pretrained model. Moreover, human-annotated samples are not needed for training, fine-tuning, or including in a model prompt to generate product profile recommendations and/or product profile quality indicators. As such, embodiments described herein improve computing resource consumption, such as computer memory and latency, at least because not as much data (e.g., parameters) is stored or used for producing the model output and computational requirements otherwise needed for training are not needed.

Various terms and phrases are used throughout the description provided herein. A brief overview of such terms and phrases is provided here for ease of understanding, but more details of these terms and phrases is provided throughout.

A product profile refers to text, images, and any other data describing a product or how the product is manufactured. The product profile can be presented to users (consumers) and/or be used to search for products. The product profile can include various features associated with a product. A product feature refers to an aspect or type of information associated with a product or product profile. A product feature includes, for example, a title, a description, an image, an attribute, and/or the like. A product attribute refers to a specific characteristic or aspect of a product (e.g., size, value, color, aesthetics, etc.). Product profiles may be stored in any type of database. The database of product profiles may be referred to as a catalog, set, or listing of product profiles. In some cases, the product profiles are stored in an association with a product information management (PIM) system or service. Such a PIM system or service refers to software or technology designed to centralize, manage, create, and/or distribute product information regarding products for a business.

A consumer generally refers to a customer or shopper that is interested in a product or products. In this regard, a consumer may be searching for products in an e-commerce service, such as an e-commerce website or application. A merchandizer generally refers to an entity or business associated with products. In this regard, in some embodiments, a merchandizer supports the management of products and/or product profiles associated with products in a catalog associated with the merchandizer.

Catalog content generally refers to content associated with or included in a product catalog. Catalog content includes, for example, product purchases and product comparisons. Consumer content generally refers to content produced by a consumer. Consumer content includes consumer reviews, product question and answers, search queries, and other data provided by a consumer (e.g., shopper or previous purchaser of a product).

A candidate feature refers to candidates, or possibilities, for providing as a recommendation for a product profile. Candidate features can be identified using named entity recognition and/or generative models.

Product-type context refers to data associated with a particular product type. A product type, also referred to as a product category, may be defined in levels of granularity (e.g., broad categories: fashion, sports, technology, etc.; or more narrow categories: pants, shirts, shoes, dresses, etc.). In some cases, product-type context includes candidate features (e.g., extracted from catalog content and/or consumer content) associated with a particular product type. Further, in some cases, relevance scores may be used to select candidate features for a product-type context and/or included in a product-type context (e.g., along with corresponding candidate features). In embodiments, a relevance score represents an extent or distance of a candidate feature (e.g., candidate attribute) to the product profile, or portion thereof. For example, cosine similarity computing distance between a particular candidate attribute and the product profile may be generated.

A product profile recommendation refers to a recommendation for a product profile. Product profile recommendations can be specific to a particular product profile feature. For example, a product profile recommendation may be an attribute recommendation to recommend a new or updated attribute to include in a product profile.

A product profile quality indicator, or a quality indicator, generally refers to an indication of quality of a product profile, or a portion thereof (e.g., attributes). A quality indicator can be represented in a number of ways, including, for example, a score or measure of quality.

A generative model generally refers to a type of machine learning model that learns to generate new data. An example of a generative model is a large language model (LLM). A language model is a statistical and probabilistic tool that determines the probability of a given sequence of words occurring in a sentence (e.g., via next sentence prediction (NSP) or minimal learning machine (MLM)). In this way, it is a tool that is trained to predict the next word in a sentence. A language model is called a large language model when it is trained on an enormous amount of data.

### Overview of Exemplary Environments for Generating Product Profile Recommendations and Quality Indicators to Enhance Product Profiles

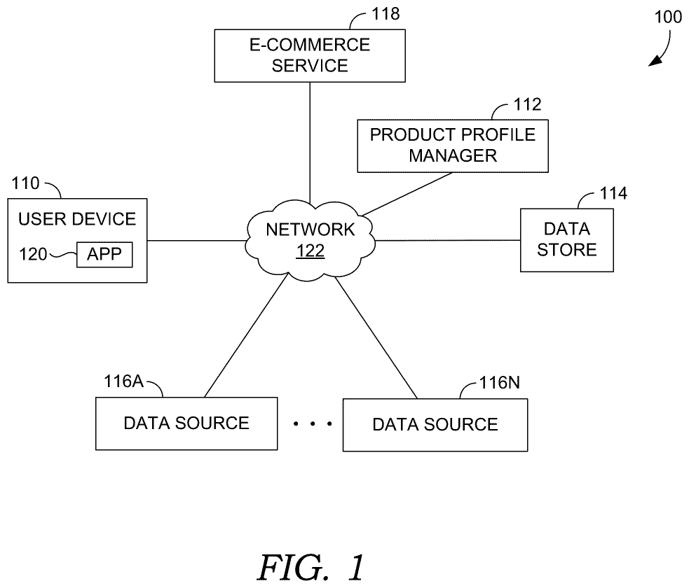

Referring initially to FIG. 1, a block diagram of an exemplary network environment 100 suitable for use in implementing embodiments described herein is shown. Generally, the system 100 illustrates an environment suitable for enhancing product profiles. In particular, product profile enhancement occurs, for example, by generating product profile recommendations and/or assessing product profile quality, in accordance with embodiments described herein. Among other things, embodiments described herein efficiently generate product profile recommendations. A product profile recommendation generally refers to a recommendation or suggestion associated with a product profile. A product profile recommendation typically relates to a feature of a product profile, such as a title, attributes, description, category, images, etc. For example, a product profile recommendation may be an attribute recommendation that provides a new or updated recommendation for an attribute to include in a product profile associated with a product. Further, embodiments described herein efficiently generate quality indicators associated with product profiles. A quality indicator generally refers to an indication of quality of a product profile, or a portion thereof. As one example, a quality indicator indicates quality associated with a set of attributes in a product profile. Advantageously, generating and providing product profile recommendations and/or quality indicators associated with product profiles in an efficient manner enables a user (e.g., merchandizer creating or managing product profiles) to have a better understanding of product profiles and opportunities for improving product profiles without having to manually track down the desired data using various systems and queries thereto.

The network environment 100 includes user device 110, a product profile manager 112, a data store 114, data sources 116a-116n (referred to generally as data source(s) 116), and an e-commerce service 118. The user device 110, the product profile manager 112, the data store 114, the data sources 116a-116n, and e-commerce service 118 can communicate through a network 122, which may include any number of networks such as, for example, a local area network (LAN), a wide area network (WAN), the Internet, a cellular network, a peer-to-peer (P2P) network, a mobile network, or a combination of networks.

The network environment 100 shown in FIG. 1 is an example of one suitable network environment and is not intended to suggest any limitation as to the scope of use or functionality of embodiments disclosed throughout this document, and nor should the exemplary network environment 100 be interpreted as having any dependency or requirement related to any single component or combination of components illustrated therein. For example, the user device 110 and data sources 116a-116n may be in communication with the product profile manager 112 and/or the e-commerce service 118 via a mobile network or the Internet, and the product profile manager 112 and/or e-commerce service 118 may be in communication with data store 114 via a local area network. Further, although the environment 100 is illustrated with a network, one or more of the components may directly communicate with one another, for example, via HDMI (high-definition multimedia interface) and DVI (digital visual interface). Alternatively, one or more components may be integrated with one another. For example, at least a portion of the product profile manager 112 and/or data store 114 may be integrated with the user device 110, data sources 116, and/or e-commerce service 118. For instance, a portion of the product profile manager 112 may be integrated with a user device, while another portion of the product profile manager 112 may be integrated with an e-commerce service 118.

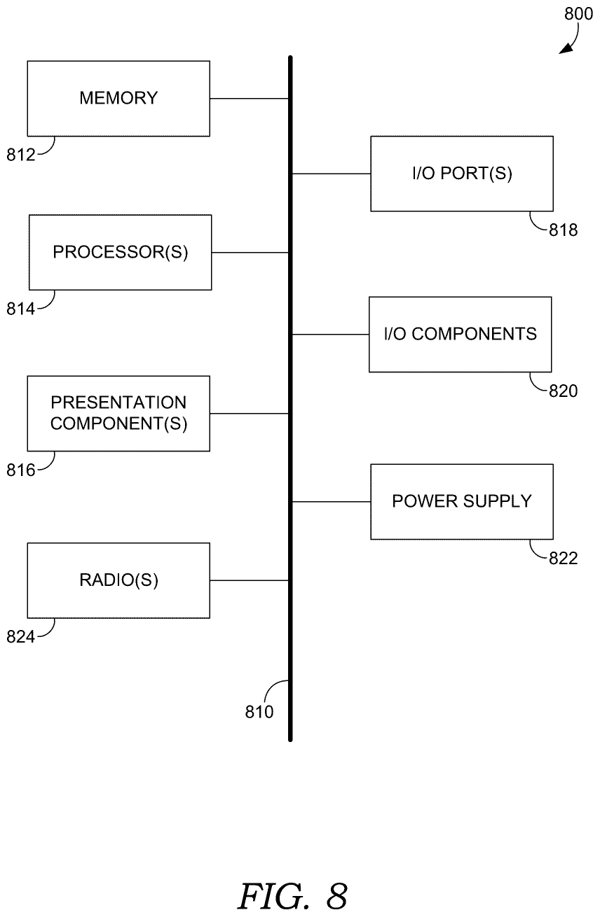

The user device 110 can be any kind of computing device capable of facilitating enhancement of product profiles. In this regard, the user device 110 can facilitate generating and/or providing product profile recommendations and/or quality indicators associated with product profiles. For example, in an embodiment, the user device 110 can be a computing device such as computing device 800, as described above with reference to FIG. 8. In embodiments, the user device 110 can be a personal computer (PC), a laptop computer, a workstation, a mobile computing device, a PDA, a cell phone, or the like.

The user device can include one or more processors, and one or more computer-readable media. The computer-readable media may include computer-readable instructions executable by the one or more processors. The instructions may be embodied by one or more applications, such as application 120 shown in FIG. 1. The application(s) may generally be any application capable of facilitating enhancement of product profiles (e.g., generating product profile recommendations and/or product profile quality indicators). In some implementations, the application(s) comprises a web application, which can run in a web browser, and could be hosted at least partially server-side (e.g., via a server). In addition, or instead, the application(s) can comprise a dedicated application. In some cases, the application is integrated into the operating system (e.g., as a service).

User device 110 can be a client device on a client-side of operating environment 100, while product profile manager 112 and/or e-commerce service 118 can be on a server-side of operating environment 100. Product profile manager 112 and/or e-commerce service 118 may comprise server-side software designed to work in conjunction with client-side software on user device 110 so as to implement any combination of the features and functionalities discussed in the present disclosure. An example of such client-side software is application 120 on user device 110. This division of operating environment 100 is provided to illustrate one example of a suitable environment, and it is noted there is no requirement for each implementation that any combination of user device 110, product profile manager 112, and/or e-commerce service 118 must remain as separate entities.

In an embodiment, the user device 110 is separate and distinct from the product profile manager 112, the data store 114, the data sources 116, and the e-commerce service 118 illustrated in FIG. 1. In another embodiment, the user device 110 is integrated with one or more illustrated components. For instance, the user device 110 may incorporate functionality described in relation to the product profile manager 112 and/or e-commerce service 118. For clarity of explanation, embodiments are described herein in which the user device 110, the product profile manager 112, the data store 114, the data sources 116, and the e-commerce service 118 are separate, while understanding that this may not be the case in various configurations contemplated.

As described, a user device, such as user device 110, can facilitate generating and/or providing product profile recommendations and/or product profile quality indicators. A user device 110, as described herein, is generally operated by an individual or entity that may initiate generation and/or that views product profile recommendation(s) and/or product profile quality indicator(s). In some cases, such an individual may be, or be associated with, a contributor, manager, developer, or creator of a product profile or catalog of product profiles. In this regard, the user may be a merchandizer, or associated with a merchandizer, and interested in enhancing a product profile(s) in a catalog, for example, to understand how to enhance or improve a product profile(s), to understand how to market or advertise a product, to provide in relation to the product profile, etc. In other cases, an individual or entity operating the user device may be an individual associated with an e-commerce service, that is, a service that facilitates generation and/or presentation of product profiles. For example, a user may be interested in enhancing product profiles to provide better or more relevant results or language for a viewer of the product profiles. In yet other cases, such an individual may be a person interested in, or a consumer of, products, or product profiles associated therewith. For example, an individual may navigate to view a product profile associated with a product (e.g., included as a search result via an e-commerce website). Based on navigating to view the product profile, and/or searching for the particular product or product profile, the user may be provided with product profile recommendation(s) associated with the product. In this way, the viewer of the product profile may be presented with additional product profile features (e.g., attributes) related to the product that can be valuable or interesting to the viewer.

In some cases, generation or provision of product profile recommendations and/or product profile quality indicators may be initiated at the user device 110. For example, in some cases, a user may directly or expressly select to generate or view product profile recommendations and/or product profile quality indicators related to a product profile or set of product profiles. For instance, a user desiring to view product profile recommendations associated with a product or product profile may specify a desire to view a product profile recommendation. To this end, a user of the user device 110 that initiates generating and/or providing product profile recommendations and/or product profile quality indicators may be a user that performs some aspect of product profile creation, product marketing, or the like. As another example, a user desiring to view product profile recommendations and/or product profile quality indicators may select a link or icon to view such information. In other cases, a user may indirectly or implicitly select to generate or view product profile recommendations and/or product profile quality indicators related to a product or product profile. For instance, a user may navigate to an e-commerce store application or website. Based on the navigation to the e-commerce store application or website, the user may indirectly indicate to generate or view a product profile recommendation(s) associated with a product or product profile(s). In some cases, such an indication may be based on generally navigating to the application or website. For instance, a product profile recommendation(s) may be requested for each product profile to be, or that may be, presented in the application or website. In other cases, such an indication may be based on selecting a particular product profile to view or hovering over a particular product profile to indicate interest. In yet another example, a user of the user device 110 that initiates generation and/or provision of product profile recommendations and/or product profile quality indicators may be a user corresponding to an e-commerce service. For instance, an e-commerce service that hosts product profiles associated with various products (e.g., for selling) may desire to generate product profile recommendations for a set of products. In this way, the user may select one product profile or a batch of product profiles and, thereafter, select to generate product profile recommendations associated therewith. In other embodiments, initiation of product profile recommendations and/or product profile quality indicators may be automatically triggered or initiated. For instance, upon an e-commerce service obtaining a particular number of new product profiles, generation of product profile recommendations associated with the new product profiles can be automatically triggered.

Generation and/or provision of product profile recommendations and/or product profile quality indicators may be initiated and/or presented via an application 120 operating on the user device 110. In this regard, the user device 110, via an application 120, might allow a user to initiate generation or presentation of product profile recommendations and/or product profile quality indicators. The user device 110 can include any type of application and may be a standalone application, a mobile application, a web application, or the like. In some cases, the functionality described herein may be integrated directly with an application or may be an add-on, or plug-in, to an application. One example of an application that may be used to initiate and/or present product profile recommendations and/or product profile quality indicators includes any application in communication with an e-commerce service, such as e-commerce service 118. For example, initiating or viewing product profile recommendations and/or product profile quality indicators may occur via an e-commerce website or application operating on the user device that communicates with e-commerce service 118. Another example of an application that may be used to initiate and/or present product profile recommendations and/or product profile quality indicators includes any application in communication with a product information management (PIM) service or system. A PIM system or service generally refers to software designed to centralize, manage, create, and/or distribute product information regarding products for a business.

Although embodiments described above generally include a user or individual inputting or selecting (either expressly or implicitly) to initiate or view product profile recommendations and/or product profile quality indicators, as described below, such initiation may occur in connection with an e-commerce service, such as content service 118, or other service or server, such as a PIM service. For example, an e-commerce service and/or a PIM service may initiate generation of product profile recommendations and/or product profile quality indicators on a periodic basis. Such product profile recommendations and/or product profile quality indicators can then be presented and/or be stored, and, thereafter, accessed to provide to a user device for viewing (e.g., based on a user navigating to a particular product profile).

The user device 110 can communicate with the product profile manager 112 and/or other service, such as e-commerce service 118 and/or PIM service to initiate generation or viewing of product profile recommendations and/or product profile quality indicators. In embodiments, for example, a user may utilize the user device 110 to initiate generation of product profile recommendations and/or product profile quality indicators via the network 122. For instance, in some embodiments, the network 122 might be the Internet, and the user device 110 interacts with the product profile manager 112 (e.g., directly or via another service such as the e-commerce service 118) to initiate generation of product profile recommendations and/or product profile quality indicators. In other embodiments, for example, the network 122 might be an enterprise network associated with an organization. It should be apparent to those having skill in the relevant arts that any number of other implementation scenarios may be possible as well.

With continued reference to FIG. 1, the product profile manager 112 can be implemented as server systems, program modules, virtual machines, components of a server or servers, networks, and the like. At a high level, the product profile manager 112 manages generation of product profile recommendations and/or product profile quality indicators. In particular, the product profile manager 112 can obtain various content, such as catalog content and/or consumer content. Generally, the content corresponds with a particular product type that matches a product type of a product profile for which recommendations are being generated. Using the content, or portion thereof, the product profile manager 112 can generate a model prompt to initiate generation of a product profile recommendation. As one example, a model prompt may include product-type context and a product profile. The model prompt can be input into an LLM to obtain, as output, a product profile recommendation (e.g., an attribute recommendation). In some cases, content used as a basis for generating a product profile recommendation may correspond to data provided via data sources 116. Data sources 116a-116n may be any type of computing devices at which content may be generated or stored. For example, catalog content, including product purchases and product comparisons, as well as consumer content, including consumer reviews, product questions and answers, and search queries, may be stored or created at data sources 116a-116n. For instance, as various consumers search for and select aspects associated with product profiles presented via an e-commerce service (e.g., e-commerce service 118), the data (e.g., clicks, product comparisons, purchases, questions, reviews, etc.) can be stored or communicated to data sources 116.

In addition to generating a product profile recommendation, the product profile manager 112 can generate a quality indicator associated with a product profile. In some cases, the product profile recommendation(s) can be used to determine quality associated with the product profile, or portion thereof, for which the recommendations were generated. For example, a comparison between generated attribute recommendations and attributes existing in a product profile may be performed (e.g., via a model-based approach) to generate a quality indicator indicating quality of the product profile, or portion thereof.

In accordance with generating a product profile recommendation and/or product profile quality indicator, the product profile manager 112 can provide or output such information to the user device 110 for presentation (e.g., via application 120). By way of example, assume a user of user device 110 is viewing, creating, or modifying a product profile via application 120 operating on user device 110. Further assume the user is interested in, and selects, to generate recommendations and/or quality indicators associated therewith. In such a case, a product profile recommendation and/or a product profile quality indicator is provided to the user device 110 for presentation (e.g., in association with the product profile).

In other cases, the product profile manager 112 outputs product profile recommendations and/or product profile quality indicators to another service, such as an e-commerce service 118 or a PIM service, or a data store, such as data store 114. For example, upon generating product profile recommendations and/or product profile quality indicators, the data can be provided to e-commerce service 118, a PIM service, and/or data store 114 for subsequent use. For instance, when a user subsequently views a particular product profile via application 120 on user device 110, the product profile recommendations and/or product profile quality indicators may, in response, be provided to the user device. In yet other cases, product profile recommendations and/or product profile quality indicators may be provided for analysis of the product profile. Any number of uses of such product profile recommendations and/or product profile quality indicators may be implemented in accordance with embodiments described herein.

In embodiments, the product profile manager 112 communicates with or is a part of a PIM service. In this regard, in connection with managing a product profile maintained by a PIM, product profile recommendations and/or product profile quality indicators can be generated. Additionally or alternatively, the product profile manager 112 communicates with or is part of an e-commerce service. In this way, product profiles can be created and/or maintained within the context of the e-commerce service.

As described, the e-commerce service 118 may be any service that provides, presents, and/or sells products. To do so, the e-commerce service 118 can use product profiles that provide details associated with the products. In some cases, the e-commerce service 118 obtains a set of product profiles representing products. In some implementations, the product profiles may be generated via the e-commerce service. In other implementations, the product profiles may be generated via a PIM service. In accordance with obtaining the product profiles, the product profiles can be presented to consumers. In accordance with embodiments described herein, the product profiles presented may be enhanced product profiles. In particular, the product profiles may include or incorporate product profile recommendations provided for various features. For example, assume an attribute is recommended to add to a product profile. In such a case, the presented product profile may include the recommended attribute (e.g., based on a merchandizer selection to include the attribute in the product profile). The e-commerce service 118 may also obtain content and/or feedback (e.g., from consumers) for use in implementing aspects described herein. For example, the e-commerce service 118 may obtain catalog content or consumer content for use in generating product profile recommendations. As another example, the e-commerce service 118 may obtain consumer feedback (e.g., clicks, purchases, etc.) that may be used to train or fine-tune a feature generation model (e.g., an LLM that generates attribute recommendations).

As can be appreciated, in some cases, the product profile manager 112 may be a part of, or integrated with, the e-commerce service 118 and/or a PIM service. In this regard, the product profile manager 112 may function as a portion of the e-commerce service 118 or a PIM service. In other cases, the product profile manager 112 may be independent of, and separate from, the e-commerce service 118 and/or a PIM service. Any number of configurations may be used to implement aspects of embodiments described herein.

Advantageously, utilizing implementations described herein enables generation and presentation of product profile recommendations and/or product profile quality indicators performed in an efficient manner. Further, the product profile recommendations and/or quality indicators are generated in accordance with catalog content and/or consumer content, thereby providing diverse and comprehensive recommendations. As such, more relevant information for a user, in addition to or in the alternative to an original product profile can be viewed, thereby facilitating more effective generation of a product profile.

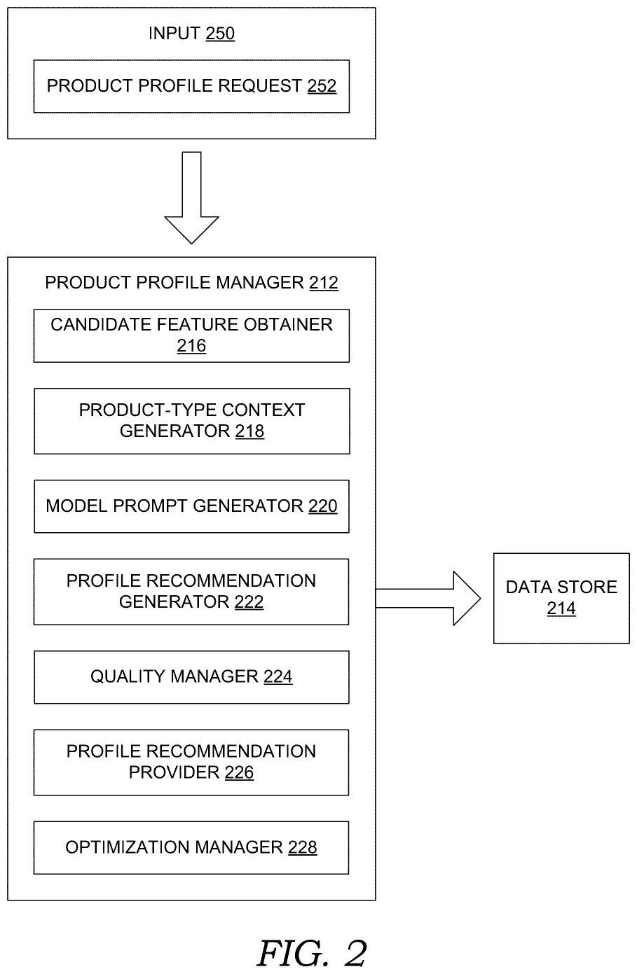

Turning now to FIG. 2, FIG. 2 illustrates an example implementation for generating and/or providing product profile recommendations to enrich product profile features via product profile manager 212. The product profile manager 212 can communicate with the data store 214. The data store 214 is configured to store various types of information accessible by the product profile manager 212 or other server or service. In embodiments, user devices (such as user devices 110 of FIG. 1), data sources (such as data sources 116 of FIG. 1), an e-commerce service (such as e-commerce service 118 of FIG. 1), and/or servers or services can provide data to the data store 214 for storage, which may be retrieved or referenced by any such component. As such, the data store 214 may store product profiles, product profile recommendations, product profile quality indicators, and/or the like. In this regard, data store 214 may store identified product profile recommendations and/or quality indicators, which can then be accessed for subsequent use to present, analyze, or update product profiles.

In operation, the product profile manager 212 is generally configured to manage generation and/or provision of product profile recommendations. In embodiments, the product profile manager 212 includes a candidate feature obtainer 216, product-type context generator 218, a model prompt generator 220, a profile recommendation generator 222, a quality manager 224, a profile recommendation provider 226, and an optimization manager 228. According to embodiments described herein, the product profile manager 212 can include any number of other components not illustrated. In some embodiments, one or more of the illustrated components 216-228 can be integrated into a single component or can be divided into a number of different components. Components 216-228 can be implemented on any number of machines and can be integrated, as desired, with any number of other functionalities or services.

The product profile manager 212 may receive input 250 to initiate generation and/or provision of product profile recommendations and/or product profile quality assessments. Input 250 may include product profile request 252. A product profile request 252 generally includes a request or indication to generate a product profile recommendation and/or assess product profile quality. A product profile request may specify, for example, an indication of a product(s) or product profile(s) for which a product profile recommendation and/or quality assessment is desired, an indication of a target consumer(s) use for generating a product profile recommendation and/or assessing quality, an indication of a product type associated with the product or product field to be analyzed, an indication of a content type(s) desired for analysis, and/or the like. A product and/or product profile may be identified in any number of ways including, for example, a unique product identifier (e.g., a stock-keeping unit [SKU], a product identifier referenced in a catalog, etc.) and/or unique product profile file identifier (e.g., assigned by a merchandizer). A product type may include any type or category of products. A product type may be provided in any extent of granularity. For example, for a pair of jeans, a product type may be “clothes,” “pants,” “denim,” or the like. A content type may indicate the type of content desired to be analyzed to generate recommendations and/or assess quality. Various types of content may be used to generate product profile recommendations and/or perform quality assessment associated with product profiles, including, for example, catalog content and consumer content. Catalog content generally refers to content included in a catalog of products. Catalog content may include product purchases, product comparisons (e.g., comparisons of products generated during consumer sessions), and/or the like. Consumer content generally refers to content generated or created by a consumer or set of consumers. Consumer content may include consumer reviews, product questions and answers, search queries, and/or the like.

A product profile request 252 may be provided by any service or device. For example, in some cases, a product profile request 252 may be initiated and communicated via a user device, such as user device 110 of FIG. 1. For example, assume a user, such as a merchandizer, accesses a website or an application associated with one or more products (e.g., PIM used to generate and/or present product catalogs, or search therefrom). In such a case, a product profile request 252 may be initiated that includes a request to generate a product profile recommendation(s) and/or assess quality associated with a product profile. For instance, in one example, the product profile request 252 may specify a product or product profile for which recommendations and/or quality assessment is desired. Such a specification may be performed in any number of ways including, for example, accessing a product catalog and selecting a particular product or product profile, providing an input query, selecting from a product or product profile from a menu, etc. In such a case, the user may specifically or directly select to view product profile recommendations and/or quality assessments associated with a product profile such that the user (e.g., merchandizer) can obtain constructive insights related to the product profile. In this way, the user may view the recommendations and/or quality assessment associated with a product profile to identify opportunities to improve or enhance the product profile. As another example, a particular product or product profile for which recommendations and/or quality assessment is desired may be specified based on a presentation of the product via the application or website, selection or other indication of interest in a product or product profile (e.g., a user pauses scrolling over the product profile or selecting the product profile to view).

In other cases, a product profile request 252 may be automatically initiated and communicated via a service, such as an e-commerce service 118 of FIG. 1. For example, a website or application service, such as an e-commerce service 118, associated with products may automatically initiate generation of recommendations and/or quality assessment associated with product profiles, for instance, based on a lapse of a time period, a reception of a set of product profiles (e.g., upon obtaining a predetermined number of product profiles), or other criteria. As can be appreciated, the automated initiation of recommendations and/or quality assessment associated with product profiles may be dynamic, for instance, based on aspects associated with the product profiles or products. For example, in cases in which product profiles are more frequently obtained, updated and/or viewed, a request may be initiated more frequently, whereas when product profiles are less frequently obtained, updated, and/or reviewed, the request for recommendations and/or quality assessment may be initiated less frequently.

Although not illustrated, input 250 may include other information communicated in association with a request. For example, and as described below as one implementation, a product profile, or a reference thereto (e.g., a link to product profile), a desired target consumer(s), a product type associated with the product, and/or a content type for generating recommendations and/or assessing quality, etc., may be provided in association with the request. For instance, in some cases, a merchandizer may provide an indication of a product profile and a corresponding product type, which is communicated in association with a request to initiate generation of a product profile recommendation(s) and/or quality assessment associated with the product profile.

The candidate feature obtainer 216 is generally configured to obtain candidate features. In this regard, the candidate feature obtainer obtains a set of candidate features that are candidates, or possibilities, for providing as a recommendation for a product profile. As described herein, a feature, or product profile feature, generally refers to an aspect of the product profile. Product profile features include, by way of example and not limitation, a title, a description, an attribute(s), a category(s), and a product image(s). Any of such product profile features may be analyzed to generate recommendations associated therewith. For example, in cases in which attributes are analyzed, product profile recommendations are generated in association with attributes. In this regard, the candidate feature obtainer 216 may obtain candidate features of a particular type. For instance, as described in association with various embodiments herein, the candidate feature obtainer 216 may obtain candidate attributes.

To obtain candidate features, the candidate feature obtainer 216 generally obtains, references, or accesses various content. In some cases, the candidate feature obtainer 216 obtains candidate features in accordance with obtaining a request, such as product profile request 252. Various content can be used to identify or obtain candidate features. Examples of content to use to obtain candidate features include catalog content and/or consumer content. Catalog content generally refers to content included in or associated with a catalog. Catalog content may include, for instance, product purchases and product comparisons. Product purchase content may refer to any content associated with previous product purchases. As one example, product profiles of previously purchased products may be obtained. As another example, product attributes associated with previously purchased products may be obtained (e.g., of a particular product type). Similar products may be described in various manners and, as such, having content associated with how different products are represented can facilitate enrichment of product profile features. Consumer content generally refers to content provided, created, and/or selected by a consumer or potential consumer of a product. Product comparisons content generally refers to content associated with product comparisons. For example, an e-commerce website may include a comparison tool that enables a consumer, or potential consumer, to initiate a comparison of two or more products (e.g., drag-and-drop to generate a comparison table to understand similarities and/or differences between products), or such a comparison may be automatically generated by the e-commerce website. Consumer content may include consumer reviews, product questions and answers (e.g., questions/answers provided by various consumers), search queries (e.g., initiated to search for a particular product or product type), or the like. Such catalog content and/or consumer content can be referenced from various types and numbers of data sources (e.g., data stores). Incorporating product features, such as product attributes, extracted from catalog content and/or consumer content provides a rich and diverse source of information on features (e.g., attributes). For instance, consumer-generated content provides rich and diverse sources of information on attributes that consumers often seek in products.

In some embodiments, the content, such as catalog content and consumer content, used to obtain or identify candidate feature corresponds with a product type associated with a product or product profile for which a recommendation and/or quality assessment is desired. For example, assume a recommendation and/or quality assessment associated with a product profile created for a pair of jeans is desired. Further, assume the pair of jeans corresponds with a “denim” product type. In such a case, content, including catalog content and consumer content, associated with other products of the “denim” product type is obtained or referenced and used to identify candidate features. In this way, product profile recommendations and/or quality assessment is performed using information or content associated with various items of jeans in the catalog. The product type associated with a product or product profile can be identified in any number of ways. For example, in some cases, the product type is included in the product profile request. In other cases, the product type is included in the product profile or in the product catalog. In yet other cases, the product type can be generated or identified using any type of technology (e.g., machine learning, natural language processing, etc.).

In some cases, the candidate feature obtainer 216 can obtain or reference content from various sources for utilization in obtaining candidate features. In some cases, content may be obtained as input 250 along with the product profile request 252. For example, in some implementations, a user (e.g., a merchandizer) may input or select content in the form of text, or a portion thereof, via a graphical user interface for use in generating product profile recommendations and/or performing quality assessment. For instance, a user, operating via a user device, desiring to view a recommendation or quality assessment associated with a particular product profile, may select or input a set of text or content for use. As another example, a merchandizer or other individual may provide a list of uniform resource locators (URLs) that includes content intended for generation of product profile recommendations and/or quality assessment thereof.

Additionally or alternatively, the candidate feature obtainer 216 may obtain content from any number of sources, such as data sources 116 of FIG. 1, or data stores, such as data store 214. In this regard, in accordance with initiating product profile recommendations and/or quality assessment, the candidate feature obtainer 216 may communicate with a data store(s) or other data source(s), including an e-commerce service (e.g., e-commerce service 118 of FIG. 1), and obtain content to generate a product profile recommendation(s) and/or quality assessment. For example, in accordance with an indication or specification of a product profile associated with a particular product type, the content associated with the particular product type can be accessed and obtained. Data store 214 illustrated in FIG. 2 may include such content, but any number of data stores and/or data sources may provide various types of content. Such data stores and data sources may include public data, private data, and/or the like.

In accordance with obtaining or accessing content, the candidate feature obtainer 216 obtains or identifies candidate features. The candidate feature obtainer 216 may obtain candidate features by facilitating identifying, generating, or extracting such candidate features in association with the content. In this way, the candidate feature obtainer 216 may include or access components that identify, generate, or extract candidate feature. In embodiments, the candidate feature obtainer 216 can facilitate generation of candidate features from various forms or modalities of data. Various types of algorithms, machine learning, models, etc., may be employed to identify, generate, or extract candidate features from various content, some of which are described herein to provide examples.

One example technology that may be used to obtain candidate features from content includes named entity recognition (NER) models or natural language processing (NLP) models. An NER generally refers to an NLP technique that identifies named entities in text and classifies the entities into predefined categories. Entities may include, but are not limited to, names, individuals, places, proper nouns, etc. The entities can be categorized in accordance with certain conditions on which the model is trained. In some cases, e-commerce data can be used to train the NER model to facilitate extraction of desired information (e.g., attributes) from text.

Another example technology that may be used to obtain candidate features from content includes generative models (e.g., GPT or Chat CPT). Generative models may be used to extract entities from content. For example, a prompt instruction may be generated to identify the most relevant keywords from a document. Other aspects may be included in the prompt, such as a target or desired number of keywords or attributes to extract, etc.

As can be appreciated, in some cases, both NER and generative model technologies may be employed to obtain candidate features. Any number or types of technologies may be used to obtain candidate features, and implementations are not intended to be limited herein.

The candidate feature obtainer 216 may obtain any type and/or amount of candidate feature attributes. For example, in some cases, any number of candidate attributes associated with a particular product type may be identified. In other cases, a maximum number or predetermined number of candidate attributes are identified for a particular product type. In yet other cases, candidate attributes are identified for all types of products. The type and amount of candidate features obtained by candidate feature obtainer 216 may vary per implementation and are not intended to limit the scope of embodiments described herein.

The product-type context generator 218 is generally configured to generate product-type context. Product-type context generally refers to context provided in association with a particular product type. As described, product type can correspond to any category or products and can be of any level of granularity. In embodiments, the product-type context includes candidate features associated with a particular product type. For example, in cases in which candidate attributes associated with the product type “soccer gear” are identified via candidate feature obtainer 216, the candidate attributes associated with “soccer gear” are included in the product-type context. As described, as catalog content and consumer content can be used to identify candidate features, the product-type context includes content that provides rich and diverse sources of information (e.g., including attributes that consumers often seek in products).

In some embodiments, the product-type context includes weights, scores, and/or ranks in association with the various candidate attributes. A weight, score, and/or rank can indicate an extent of relevancy. In some cases, a relevance score represents an extent or distance of the candidate feature (e.g., candidate attribute) to the product profile, or portion thereof. For example, cosine similarity computing distance between a particular candidate attribute and the product profile may be generated. The relevancy score, or weight/rank, can be included in the product-type context.

Additionally or alternatively, weights, scores, and/or ranks can be used to select or filter a particular set of candidate features to include in the product-type context. For example, candidate features having a greater score or ranking can be selected for including in the product-type context. By way of example only, for candidate feature attributes obtained by analyzing consumer content, most frequently occurring attributes in product comparisons may be selected for inclusion in the product-type context.

The model prompt generator 220 is generally configured to generate model prompts. As used herein, a model prompt generally refers to an input, such as a text input, that can be provided to profile recommendation generator 222, such as an LLM, to generate an output in the form of a product profile recommendation(s). As described herein, a product profile recommendation generally refers to recommendation related to an aspect or feature of a product profile. In this regard, a product profile recommendation may be a recommendation for a new or enriched attribute, title, description, category, product image, etc. In embodiments, a model prompt generally includes text to influence a machine learning model, such as an LLM, to generate text having a desired content and structure. A model prompt typically includes text given to a machine learning model to be completed. In this regard, a model prompt generally includes instructions and, in some cases, desired output. A model prompt may include any type of information. In accordance with embodiments described herein, a model prompt may include various types of text data. In particular, a model prompt generally includes text data corresponding to product profiles, or portions thereof. Although generally described as text-based model prompts, as can be appreciated, a multi-modal LLM may be used that accepts inputs of multiple modes, including images.

In embodiments, the model prompt generator 220 is configured to select a set of content or text for which to use to generate a product profile recommendation(s). For example, assume a product profile recommendation is to be generated for a particular product profile or product. In such a case, the model prompt generator 220 may select a particular product profile and a set of product-type context to use for generating a product profile recommendation(s) in association with the product profile. In this way, the model prompt generator 220 may select a set of product-type context data from the entire product-type context data or may select all the generated product-type context data. In embodiments, the particular product-type context data generally corresponds to the type of product for which the recommendation is being generated. For example, for a product profile recommendation associated with a product of a “denim” category, product-type context generated in association with the “denim” product type is generally selected for inclusion in the model prompt. In some cases, the product-type context data includes the scores generated in association with the product-type context generator 218 (e.g., relevancy scores).

The product profile, or portion thereof, to include in the model prompt may be obtained in any number of ways. For example, a product profile, or portion thereof, may be provided in a product profile request, referenced from a data store (e.g., a data store storing a catalog including various product profiles), and/or the like.

Data for the model prompt may be selected based on any number or type of criteria. As one example, text data may be selected to be under a maximum number of tokens required by a profile recommendation generator, such as an LLM. For example, assume an LLM includes a 5,000-token limit. In such a case, text data totaling less than the 5,000-token limit may be selected. Such text data selection may be based on, for example, scores or weights. For instance, product-type context data more associated with a product profile (e.g., as indicated by a relevancy score) may be selected over product-type context data less associated with a product profile.

Other types of information to include in a model prompt may include an instruction to generate a product profile recommendation (e.g., for a particular product feature), a target consumer to view the product profile, and/or the like, depending on the desired implementation or output. In accordance with embodiments herein, the instruction can specify to generate one or more product profile recommendations for the provided or corresponding product profile. More specifically, the instruction can specify to generate a product profile recommendation(s) associated with a particular product feature. As one example, an instruction may specify to generate one or more recommended attributes to supplement or modify the attributes included in the product profile.

In some embodiments, an LLM can be instructed to identify a set of scores or probabilities associated with product profile recommendations. For example, for each product profile recommendation generated, the LLM can provide a corresponding score indicating the strength of the recommendation. In some cases, a sample recommendation may be provided in the model prompt. In this way, the LLM may use the sample recommendation as reference for generating a product profile recommendation. For example, a sample attribute may be provided in the example prompt. In this way, the LLM may use the sample attribute as reference for identifying a new attribute or enriched attribute for the product profile. Additionally or alternatively, a sample product profile associated with a sample recommendation may be identified and provided in a model prompt, such that the LLM may use the sample product profile as a reference for identifying recommendations.

In addition, a model prompt may also include output attributes. Output attributes generally indicate desired aspects associated with an output, such as a product profile recommendation (e.g., indicating a recommended new or enriched attribute for a product profile). For example, an output attribute may indicate a target temperature to be associated with the output. A temperature refers to a hyperparameter used to control the randomness of predictions. Generally, a low temperature makes the model more confident, while a higher temperature makes the model less confident. Stated differently, a higher temperature can result in more random output, which can be considered more creative. On the other hand, a lower temperature generally results in a more deterministic and focused output. A temperature may be a default value, a value based on user input, or a determined value. As another example, an output attribute may indicate a length of output. For example, a model prompt may include an instruction for a desired number of recommendations (e.g., in association with a product profile). As another example, a model prompt may include an instruction for a maximum number of characters or a target range of characters. As another example, an output attribute may indicate a target language for generating the output. For example, the text data may be provided in one language, and an output attribute may indicate to generate the output in another language. Any other instructions indicating a desired output is contemplated within embodiments of the present technology.

The model prompt generator 220 may format the data and output attributes in a particular form or data structure. One example of a data structure for a model prompt is as follows:

```
  { Instruction to Generate a Product Profile Recommendation (e.g., Identify
new attributes for a product associated with the given PRODUCT PROFILE based
on the given PRODUCT-TYPE CONTEXT)
  { Product Profile (e.g., including existing set of attributes for the product)
  { Product-Type Context (e.g., including candidate attributes identified from
catalog content and consumer content)
  { Output Attributes
```

As described, in embodiments, the model prompt generator 220 generates or configures model prompts in accordance with size constraints associated with a machine learning model. As such, the model prompt generator 222 may be configured to detect the input size constraint of a model, such as an LLM or other machine learning model. Various models are constrained on a data input size they can ingest or process due to computational expenses associated with processing those inputs. For example, a maximum input size of 14,096 tokens can be programmatically set. Other input sizes may not necessarily be based on token sequence length, but other data size parameters, such as bytes. Tokens are pieces of words, individual sets of letters within words, spaces between words, and/or other natural language symbols or characters (e.g., %, $, !, etc.). Before a language model processes a natural language input, the input is broken down into tokens. These tokens are not typically parsed exactly where words start or end—tokens can include trailing spaces and even sub-words. Depending on the model used, in some embodiments, models can process up to 4,097 tokens shared between prompt and completion. Some models (e.g., GPT-3) takes the input, converts the input into a list of tokens, processes the tokens, and converts the predicted tokens back to the words in the input. In some embodiments, the model prompt generator 220 detects an input size constraint by simply implementing a function that calls a routine that reads the input constraints.

As described, the model prompt generator 220 can determine which data, for example, obtained by the product-type context generator 218 is to be included in the model prompt. In some embodiments, the model prompt generator 220 takes as input the input size constraint and the text data to determine what and how much data to include in the model prompt. By way of example only, assume a model prompt is being generated in relation to a particular product profile. Based on the input size constraint, the model prompt generator 220 can select which text of the product-type context to include in the model prompt. As described, such a data selection may be based on any of a variety of aspects. As one example, the model prompt generator 220 can first call for the input size constraint of tokens. Responsively, the model prompt generator 220 can then tokenize each of the data candidates to generate tokens, and then responsively and progressively add each text data ranked/weighted from highest to lowest if and until the token threshold (indicating the input size constraint) is met or exceeded, at which point the model prompt generator 220 stops.

The model prompt generator 222 may generate any number of model prompts. As one example, an individual model prompt may be generated for a particular product profile. In this way, a one-to-one model prompt may be generated for a corresponding product profile. As such, product-type context associated with a particular product type corresponding to the product profile is included in the model prompt. As another example, a particular model prompt may be generated to initiate product profile recommendations for multiple product profiles. For instance, a model prompt may be generated to include an indication of a first product-type context associated with a first product profile, a second product-type context associated with a second product profile, and so on.

The profile recommendation generator 222 is generally configured to identify or generate product profile recommendations. As described herein, product profile recommendations generally refer to recommendations that enrich the product profile. For example, the product profile recommendations may include new features to add to the product profile or suggestions for modifying features of a product profile. The product profile recommendations may relate to any type of product profile features. For example, product profile recommendations may include new attributes to include in a product profile. Additionally or alternatively, product profile recommendations may be directed to the title, description, category, and product images, among other features, associated with a product profile.

In this regard, the profile recommendation generator 222 utilizes product-type context to generate a product profile recommendation(s) associated with a particular product profile. Generally, the product profile recommendation is specific to a particular feature (e.g., attributes). In embodiments, the profile recommendation generator 222 takes, as input, a model prompt generated by the model prompt generator 220. Based on the model prompt, the profile recommendation generator 222 can generate a product profile recommendation or set of product profile recommendations associated with a product profile(s) indicated in the model prompt. For example, assume a model prompt includes a product profile and product-type context that includes candidate attributes identified via content associated with the same product type as the product profile. In such a case, the profile recommendation generator 222 generates a recommendation for an attribute(s) to supplement the product profile based on the product-type context included in the model prompt.

As described, a product profile recommendation generally refers to a recommendation related to a product profile. Generally, the product profile recommendation recommends a product profile feature. For example, a product profile recommendation recommends an attribute, a title, a description, a category, or a product image for a product profile (e.g., to supplement or modify an existing product profile feature). The product profile recommendation can represent or illustrate aspects that are, or are likely to be, of interest to consumers. A product profile recommendation can be in any number of forms. In some embodiments, a product profile recommendation includes an indication of a feature (e.g., a specific attribute suggestion). In other embodiments, the product profile recommendation includes an indication of the feature and a corresponding score, for example, indicating a likelihood of interest by consumers or indicating a distance from existing features in the product profile recommendation. In this regard, for a particular product profile, an LLM can output a set of identified attributes, or other product features, and corresponding scores.

As described, any number of product profile recommendations can be generated for a product profile. For example, in one embodiment, an instruction to generate multiple (e.g., three) product profile recommendations may be provided in the model prompt. As another example, any number of product profile recommendations identified may be provided as output. As yet another example, any number of product profile recommendations that satisfy a threshold level of probability may be provided as output.

The profile recommendation generator 222 may be or include any number of machine learning models or technologies. In some embodiments, the machine learning model is a Large Language Model (LLM). A language model is a statistical and probabilistic tool which determines the probability of a given sequence of words occurring in a sentence (e.g., via NSP or MLM). In this way, it is a tool that is trained to predict the next word in a sentence. A language model is called a large language model when it is trained on an enormous amount of data. Some examples of LLMs are OPT, FLAN-T5, BART, GOOGLE's BERT, and OpenAI's GPT-2, GPT-3, and GPT-4. For instance, GPT-3, is a large language model with 175 billion parameters trained on 570 gigabytes of text. These models have capabilities ranging from writing a simple essay to generating complex computer codes-all with limited to no supervision. Accordingly, an LLM is a deep neural network that is very large (billions to hundreds of billions of parameters) and understands, processes, and produces human natural language by being trained on massive amounts of text. In embodiments, an LLM generates representations of text, acquires world knowledge, and/or develops generative capabilities.

As such, as described herein, the profile recommendation generator 222, in the form of an LLM, can obtain the model prompt and, using such information in the model prompt, generate a product profile recommendation(s) for a product profile(s). In some embodiments, the profile recommendation generator 222 takes on the form of an LLM, but various other machine learning models can additionally or alternatively be used.

In embodiments, the profile recommendation generator 222 is fine-tuned. Fine-tuning generally refers to the process of retraining a pretrained model on a new dataset without training from scratch. Fine-tuning typically takes weights of a trained model and uses those weights as the initialization value, which is then adjusted during fine-tuning based on the new dataset. Fine-tuning can be used in cases in which an industry-specific data set exists that can be used to fine-tune the model. In some implementations, the LLM is fine-tuned on multiple product type-attributes to leverage its text generation ability. In this regard, the data set used for fine-tuning may include a product type and attribute pairs. Attributes may be represented in any number of forms, such as in JavaScript Object Notation (JSON) format to represent attribute key values. By way of example only, a product type may be “denim,” and an attribute may be the size value. The LLM can be fine-tuned using the set of product type-attribute pairs.

Providing the product type in the input can ensure the output is automatically conditioned on the product type. Further, product-type context provided to the LLM further improves the distribution of the generated product profile recommendations (e.g., attribute recommendations). In this regard, the LLM can generate a set of product profile recommendations that it may or may not have seen before, thereby enabling zero-shot and value-absent inference on features (e.g., attributes).

The quality manager 224 is generally configured to manage quality associated with product profiles, or portions thereof. Quality assessment can be used to provide users, such as merchandizers, the ability to analyze the quality of product profiles. For example, quality assessment can be used by a merchandizer to narrow down or modify product profiles that don't meet a desired quality standard. As another example, quality assessment can be used by a merchandizer to narrow down on or modify features of product profiles, such as attributes, that do not attain a desired quality threshold.

In one embodiment, quality manager 224 generates a quality indicator, or an indication of a quality. The quality indicator, or quality score, generally indicates quality of the product profile, or a portion thereof (e.g., product profile attributes). A quality indicator can be represented in any number of ways, including numerical values, text, scores, probabilities, etc.

A quality indicator for a product profile, or a portion thereof, can be generated in any number of ways. For example, in some cases, a rule-based analysis may be used to generate a quality indicator for a product profile or a feature thereof. Rule-based analysis generally refers to analysis or validation of structural characteristics of a product profile feature (e.g., attributes), such as length, keyword presence, completeness, etc. A rule or set of rules for a rule-based analysis can be defined or provided by a user, such as a merchandizer. In some cases, a rule or set of rules for generating a quality indicator may be a specific a product catalog. For instance, a merchandizer associated with a product catalog may provide a set of rules for use in generating a quality indicator(s). In some cases, rules may be specific to a particular feature. For example, a rule may reference a number of attributes (e.g., a product profile with at least five attributes has a strong quality). In other cases, rules may be applied across product features (e.g., attributes that are specified in the product profile and included in the title have a stronger quality). Rules may also be applied to typos or grammatical errors, structure, and/or the like.

Additionally or alternatively, a model-based analysis may be used to generate a quality indicator for a product profile or a feature thereof. Model-based analysis generally refers to analysis using a model. For example, a quality score may be generated by deep learning models trained on crowdsourced datasets of product profiles scored using quality dimensions defined by domain experts. As another example, a quality score may be generated based on comparison of LLM-generated refinements and existing profile text content using a model, such as bilingual evaluation understudy (BLEU), bidirectional encoder representations from transforms (BERT) Score, beam search, etc.

In some cases, a model-based analysis is used to generate a quality indicator that indicates a measurement (e.g., of entropy) between a generated recommended feature (e.g., attribute) and a corresponding feature in the product profile. In this way, the product profile recommendation(s) output from the profile recommendation generator 222 can be compared to the corresponding feature in the product profile. For example, assume an attribute recommendation is generated in association with a product profile. In such a case, a quality indicator can be determined based on a comparison of the attribute recommendation with one or more attributes existing in the product profile. Entropy generally refers to a measure of the uncertainty or randomness of text. Entropy can reflect a comparison of or information difference between two sets of text (e.g., the generated recommended feature and feature [s] in product profile). In some embodiments, the quality manager 224 may be, include, or use a text evaluation model, such as BLEU or BERTScore, to generate a quality score related to entropy.

In some cases, multiple quality indicators can be generated to reflect quality of a product profile or particular feature. For example, a single quality indicator may be generated for rule-based analysis and a separate quality indicator may be generated for model-based analysis. As another example, various quality indicators can be generated for each rule used in rule-based analysis and each model used in model-based analysis. By way of example only, assume three rules are analyzed for rule-based analysis and one model is used for model-based analysis. In identifying quality of a particular attribute or a set of attributes, the quality indicator or score can be generated for each rule and the model, resulting in four different quality indicators. As can be appreciated, in some cases, such quality indicators can be aggregated in a way to generate a global quality indicator. Continuing with the above example, the four different quality indicators can be used to generate an average or weighted average to represent the quality of the particular attribute or set of attributes. Further, in cases in which multiple features are analyzed for quality, a global quality indicator that indicates quality of the entire product profile can be generated by aggregating quality indicators representing various features (e.g., title, attributes, etc.). In some cases, a global quality indicator can be generated using a weighted rubric scoring model. Such a model may learn the importance of feature-level quality on consumer metrics for the product, such as clicks, add-to-cart, etc.

As can be appreciated, the quality manager 224 may generate a quality indicator for a product profile and/or for a feature thereof. For example, a quality indicator for a product profile may indicate a quality of the product profile in its entirety. With regard to a feature, a quality indicator may indicate a quality of the feature generally or of a particular feature. For example, a quality indicator may indicate a quality of the set of attributes in a product profile or may indicate a quality of a particular attribute in the product profile. Generally, the quality indicator reflects the quality of features existing in the product profile, but in some cases may additionally or alternatively reflect the quality of recommended features (e.g., a recommended attribute for a product profile).

The profile recommendation provider 226 is generally configured to provide product profile recommendations and/or quality indicators. Generally, a product profile recommendation(s) is provided for utilization, for example, to identify an option for supplementing or enriching a product profile, or a portion thereof. In this regard, the profile recommendation provider 226 can provide a product profile recommendation, such as an attribute recommendation for a product profile, for display via a user device (e.g., a merchandizer device) or to store for subsequent viewing. To this end, in cases in which the product profile manager 212 is remote from the user device, the profile recommendation provider 226 may provide a product profile recommendation(s) to a user device for display to a user interested in the product profile, or product associated therewith. Alternatively or additionally, the product profile recommendation may be provided to a data store for storage or another component or service, such as a PIM service or an e-commerce service (e.g., e-commerce service 118 of FIG. 1). Such a component or service may then provide the product profile recommendation for display, for example, via a user device. For instance, as described herein, in some cases, product profile recommendations may be generated in a periodic manner. As one example, product profile recommendations may be generated for a set of product profiles in off-hours (hours in which computing resources are more available and not used by other processes). Such product profile recommendations can then be stored, for example, in data store 214. Thereafter, assume a user navigates, via a user device, to a website or application providing various product profiles. In association with navigating to the website/application, or a particular product profile associated therewith, a service can access an appropriate product profile (e.g., corresponding to the particular product) and provide the product profile recommendations for display in association with the corresponding product profile.

Additionally or alternatively, the profile recommendation provider 226 may provide quality indicators. For example, in association with presenting a product profile, or a portion thereof (e.g., attribute features), a corresponding quality indicator(s) can be presented for display. In some cases, a quality indicator(s) is provided to a data store for storage or another component or service, such as a PIM service or an e-commerce service (e.g., e-commerce service 118 of FIG. 1). Such a component or service may then provide the product profile recommendation for display, for example, via a user device.

A product profile recommendation(s) and/or quality indicator(s) associated with a product profile may be provided for display in any number of ways. In some examples, the product profile recommendation(s) and/or quality indicator(s) is provided in association with the corresponding product profile. For example, in accordance with presenting a product profile, the corresponding product profile recommendation and/or quality indicator may be presented (e.g., concurrently therewith). In some cases, the product profile recommendation(s) and/or quality indicator(s) is automatically displayed in association with the product profile. In other cases, a user may select to view the product profile recommendation(s) and/or quality indicator(s). For instance, a link or menu may be presented that, if selected, presents the product profile recommendation and/or quality indicator (e.g., integrated with the product profile, or provided in a separate window or pop-up text box). In embodiments, a product profile recommendation and/or quality indicator is generated and provided for display in real time. In this way, in response to an indication to identify a product profile recommendation and/or quality indicator, the corresponding data is identified and provided for display in real time.

By way of example only, assume a user, such as a merchandizer, is creating or evaluating a product profile for a particular product. Further assume the product profile includes three attributes associated with the product. In accordance with embodiments described herein, further assume an additional two attributes are generated as recommendations and a quality score associated with the existing three attributes is generated. In such a case, in accordance with viewing the product profile, the user may select to view the quality indicator associated with the three existing attributes or the product profile as a whole. In viewing the quality indicator, the user may recognize opportunities for improving the quality of the product profile. As such, the user may select to view the two attribute recommendations (e.g., via a selection of a link “view attribute recommendations for this product profile”). In response, the user may be presented with the two attribute recommendations. In some cases, the attribute recommendations may be provided with quality scores that indicate, if incorporated into the product profile, the overall product profile quality score may increase to a new quality score.

In embodiments, the user interface enables a user to provide feedback. In this regard, in accordance with presenting a product profile recommendation, an option for providing feedback can also be presented. For example, thumbs-up (to approve the recommendation) and thumbs-down (to reject the recommendation) icons can be presented for receiving a user selection. Additionally or alternatively, feedback can be provided to modify the recommended product profile feature. For example, an attribute presented in a plural form might be modified by the user to be in the singular form. As a user selects or provides input regarding a product profile recommendation, the feedback is captured, for example, via profile recommendation provider 226. Such feedback can be used to update the recommendation to incorporate into the product profile.

In addition to provided product profile recommendations and/or quality indicators associated with a product profile, other product-related information may be provided in association with a product profile. For example, for products where complementary or compatible products are key differentiators, complementary product types/features may be identified and incorporated into product profile recommendations for specific profile features. Example implementations for identifying complementary product types/features are provided in U.S. application Ser. No. 18/162,945, which is incorporated by reference herein. As another example, where eco-friendliness of a product is a key differentiator, sustainable characteristics of the product may be identified and incorporated into product profile recommendations for specific profile features. Example implementations for identifying sustainable characteristics are provided in U.S. application Ser. No. 18/194,501, which is incorporated by reference herein. As yet another example, for products to be localized for a specific market, unit of measurement (UOM) attribute recommendations can be identified and incorporated into product profile recommendations for specific profile features. Example implementations for identifying UOM attributes are provided in U.S. application Ser. No. 18/355,880, which is incorporated by reference herein.

In embodiments, the user interface enables the user to select a product profile recommendation, such as an attribute recommendation, to incorporate into the product profile. In doing so, new recommendations and/or quality indicators may be updated. For example, assume a user selects to add a particular attribute recommendation to a product profile. Based on the selection, the product profile manager 212 can be implemented to generate new product profile recommendations based on the updated product profile. For example, based on the selected attribute recommendation, in some implementations, additional attribute recommendations may be generated. Additionally or alternatively, based on the selected attribute recommendation, in some implementations, other product profile feature recommendations (e.g., recommendations related to the title, description, etc.) may be generated.

Although the example above generates new or updated product profile recommendations based on user selections (e.g., selection of a recommendation to incorporate into the product profile), embodiments can automatically generate new or updated product profile recommendations. For example, upon generating a particular type of feature recommendation (e.g., attribute recommendation), the product profile manager 212 may automatically generate a recommendation for a different feature (e.g., title) using the recommendations.

As can be appreciated, the product profile manager 212 may operate in a recurrent or iterative manner. For example, the product profile manager 212, or a portion thereof, may generate recommendations specific to a particular type of feature and, thereafter, generate recommendations specific to another type of feature. In some embodiments, the product profile manager 212 initially generates attribute recommendations and, thereafter, proceeds to other feature types in a sequential manner. For example, as attributes may oftentimes contain core metadata of a product, the product profile manager 212 may initially audit and refine the attributes for a product profile and then proceed to facilitate refinement of non-attribute features (e.g., based on selections made by the merchandizer). In some cases, the iterative process is performed automatically (e.g., in a predetermined sequence). In other cases, the iterative process is performed based on user selection. For instance, in accordance with a user selection to include an attribute recommendation(s) in the product profile, the user may select to view recommendations for an updated or revised title or description (e.g., update description with the new attributes).

In cases in which product profile recommendations are generated in an iterative manner, the previous recommendations, or selections thereof, can be incorporated into the analysis. For example, assume an attribute is selected for inclusion in the product profile. In such a case, the product profile included as input to the LLM now includes the new attributes. The model prompt is also configured to adapt to the desired feature recommendation. For instance, to generate a recommendation related to a description, the prompt may include the product profile, the new selected attributes (e.g., as part of the product profile or separate from the product profile), and an instruction to generate a new description based on the new selected attributes. In operation, the quality manager 224 can assess quality in accordance with the new feature recommendations. For example, a new quality indicator for the description or the product profile can be generated in accordance with the new description recommendation. This iterative approach may be applied for any number of product profile features. For example, the iterative approach may be performed to update and/or assess the quality associated with each type of product profile feature.

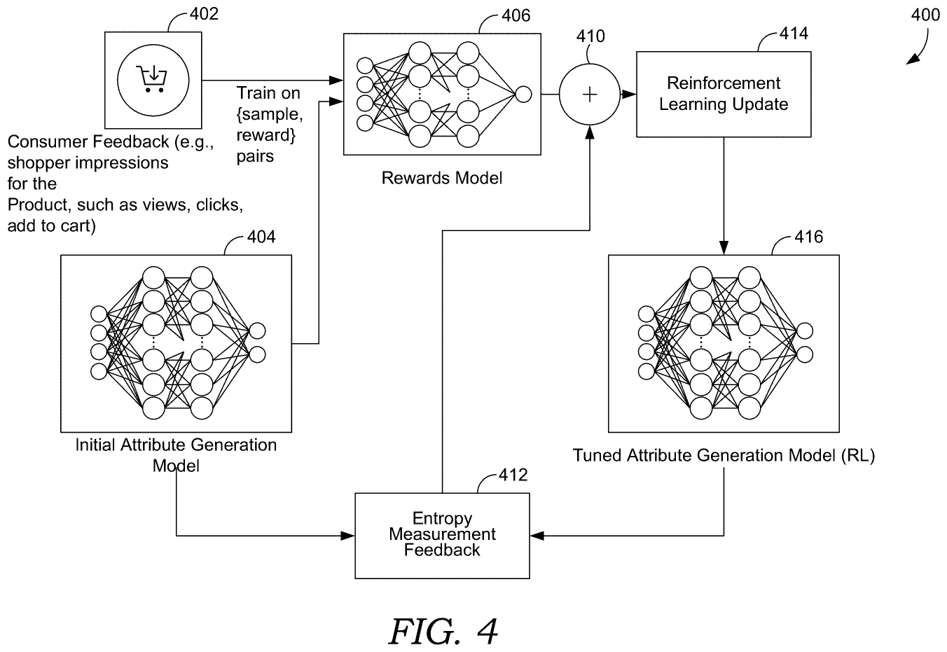

Turning to the optimization manager 228, the optimization manager 228 is generally configured to optimize or fine-tune the profile recommendation generator, for example, in the form of an LLM. In particular, the optimization manager 228 can optimize the profile recommendation generator to adapt to consumer behavior. In this regard, the optimization manager 228 implements a fine-tuning process for a product profile recommendation generator 222 (e.g., an LLM) to generate recommendations, such as attributes, that appropriately capture consumer preferences. At a high level, a reward model is trained from samples of recommendations (e.g., attributes) generated by the initial profile recommendation generator and consumer feedback to fine-tune parameters. Consumer feedback can include clicks, selections, views, add-to-cart, checkout, etc. In embodiments, feedback from entropy measurements between recommendations (e.g., attributes) generated by the profile recommendation generator and the fine-tuned profile recommendation generator is also incorporated. Such an optimization process, as described in more detail with reference to FIG. 4, aims to optimize the generated recommendations to improve product conversions over time.

### Exemplary Implementations for Generating Product Profile Recommendations and Quality Indicators to Enhance Product Profiles

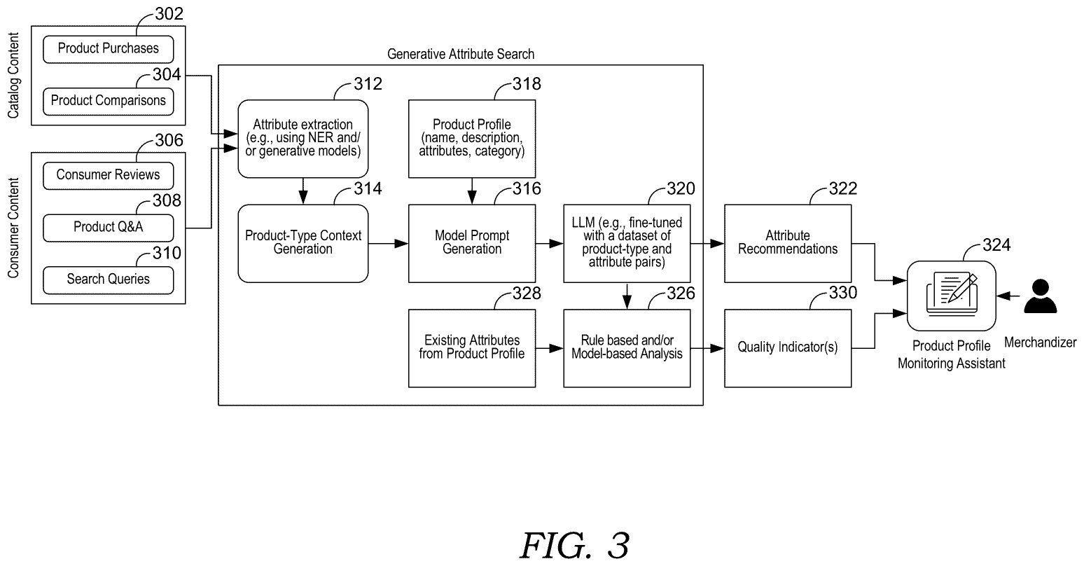

FIG. 3 provides an example implementation for generating product profile recommendations and quality indicators for a product profile. In particular, as shown in FIG. 3, the product profile recommendations are specific to attributes for a product profile. Although illustrated specific to attributes, such an implementation may be performed in a similar manner to generate recommendations for other product profile features (e.g., title, description, etc.).

As shown in FIG. 3, assume various types of content are collected. For example, catalog content, including product purchases 302 and product comparisons 304, as well as consumer content, including consumer reviews 306, product questions and answers 308, and search queries 310 can be collected. Such catalog content and consumer content can be obtained from various data sources or data stores. In embodiments described herein, such content 302-310 corresponds with a particular product type associated with a product profile being analyzed. For example, if the product profile 318 to be analyzed is a “denim” product, the content 302-310 collected corresponds with “denim” products.

As shown, at block 312, candidate attributes are extracted from the content 302-310. As the collected content 302-310 corresponds with a target product type associated with the product profile 318, the candidate attributes extracted at block 312 are generally relevant to the product profile 318. In some implementations, candidate attributes are extracted using NER and/or generative models. At block 314, product-type context is generated. In embodiments, the product-type context includes candidate attributes extracted from the content 302-310. In some cases, the product-type context further includes relevance scores and/or rankings associated with the candidate attributes. In other cases, relevance scores and/or rankings associated with the candidate attributes may be used to select or filter the candidate attributes to include in the product-type context.

At block 316, a model prompt is generated. The model prompt includes the product-type context generated at block 314 and the product profile 318. The product profile 318 generally includes various information associated with a particular product. In examples, a product profile includes a title, a description, a set of attributes, a category, and/or the like. At block 320, an LLM takes the model prompt generated at block 316 as input and outputs attribute recommendations 322. The attribute recommendations can be of any number. Generally, the attribute recommendations provide suggestions for supplemental or modified attributes for the product profile 318. In this way, the attribute recommendations 322 may be new or additional to the attributes provided in the product profile 318. In embodiments, the LMM is fine-tuned with a dataset of product-type and attribute pairs. The attribute recommendations 322 are provided for display to a user. For example, the attribute recommendations 322 can be provided to a product profile monitoring assistant 324 that presents the attribute recommendations 322 to the user (e.g., a merchandizer). In some cases, the product profile monitoring assistance 324 is incorporated into a product profile editing page to provide product profile recommendations and/or quality indicators (e.g., for each feature in the product profile as well as a rubric-based global product profile score). In some embodiments, the product profile monitoring assistant 324 enables interaction for users, such as merchandizers, to serve up fine-grained feedback regarding quality of product profiles in a catalog as well as personalized profile refinement recommendations.

Continuing with this example, a quality indicator(s) 330 can also be generated via block 326. In this regard, at block 326, rule-based analysis and/or model-based analysis is applied to generate a quality indicator(s) 330. To generate a quality indicator 330, the rule-based and/or model-based analysis may take into account (e.g., compare) the attribute recommendation output from the LLM 320 and one or more existing attributes 328 from the product profile. In embodiments, model-based analysis may include a text evaluation for entropy (e.g., via BLEU or BERTScore). The quality indicator(s) can be of any number and in any format. As described herein, in some cases, a quality indicator is specific to an existing attribute or set of existing attributes in the product profile. The quality indicator(s) 330 are provided for display to a user. For example, the quality indicator(s) 330 can be provided to a product profile monitoring assistant 324 that presents the quality indicator(s) 330 to the user (e.g., a merchandizer). In some cases, the product profile monitoring assistance 324 is incorporated into a product profile editing page to provide product profile recommendations and/or quality indicators (e.g., for each feature in the product profile as well as a rubric-based global product profile score).

Turning to FIG. 4, FIG. 4 provides an example implementation 400 for optimizing or fine-tuning the profile recommendation generator, for example, in the form of an LLM. In particular, as shown in FIG. 4, the optimization is specific to fine-tuning a profile recommendation generator that generates attributes, also referred to as an attribute generation model or LLM. Although illustrated specific to attribute generation, such an implementation may be performed in a similar manner to generate recommendations for other product profile features (e.g., title, description, etc.). Generally, the implementation 400 facilitates optimization of an attribute generation model to adapt to consumer behavior by incorporating human behavior into the fine-tuning process for an attribute generation model. In this regard, implementation 400 provides a fine-tuning process for an attribute generation model 416 (e.g., an LLM) to generate attribute recommendations that appropriately capture consumer preferences.

As shown, a rewards model 406 is trained from samples of attributes (e.g., attribute recommendations generated by the initial attribute generation model 404) and consumer feedback 402 to fine-tune parameters. Consumer feedback 402 can include impressions for the product, such as clicks, selections, views, add-to-cart, checkout, etc. In embodiments, a reward is used to represent the consumer feedback 402. The reward may be any value that reflects consumer feedback in a manner that can be consumed and used to train the rewards model 406. As one example, a reward may represent consumer feedback via a binary metric. For example, a reward may be a binary metric of a click or add-to-cart. The samples of attribute recommendations may be new attribute recommendations and/or existing attributes. Using attribute recommendations generated from the attribute generation model 404 enables fine-tuning of the rewards model, and thereafter, the attribute generation model 416 specific to newly generated attribute recommendations. In this way, the newly generated attributes are included in the product profile, and consumer feedback 402 can be obtained in association therewith. In some cases, the rewards model 406 trains on sample-reward pairs. In this way, pairs of samples and corresponding rewards are generated and provided to the rewards model 406 for training. As can be appreciated, user engagement in association with a product profile, or portion thereof (e.g., attributes), facilitates training the rewards model and, thereby, facilitates fine-tuning the parameters of the attribute generation model 416 so that the model generates attributes more aligned with consumer preferences.

Output from the rewards model 406 can be provided for use in performing reinforcement learning 410, which is used to update or fine-tune weights of the attribute generation model 416. The output from the rewards model 406 may be in any number of forms, such as a scalar reward. For example, the rewards model 406 may be a scalar model that outputs values representing human preference in association with attributes (e.g., rank attributes preferred by humans). In this way, a higher score or scalar number may be output for an attribute with a stronger consumer preference (e.g., more views, clicks, add-to-carts, etc.).

In embodiments, reinforcement learning 410 also takes as input entropy measurement feedback 412 (e.g., via Kullback-Leibler (KL) divergence probability) between attribute recommendations generated by the initial attribute generation model 404 and the fine-tuned attribute generation model 416. Relative entropy can be identified using a loss function used to fine-tune an LLM.

The reinforcement learning 410 generally performs an update process that generates updated weights, referred to herein as reinforcement learning update 414, for use in fine-tuning the attribute generation model 416. The reinforcement learning update 414 can update the weights of the attribute generation model 416 to maximize the reward (e.g., penalizing attributes associated with lower rewards, such that the LLM is fine-tuned to produce attributes that have higher rewards).

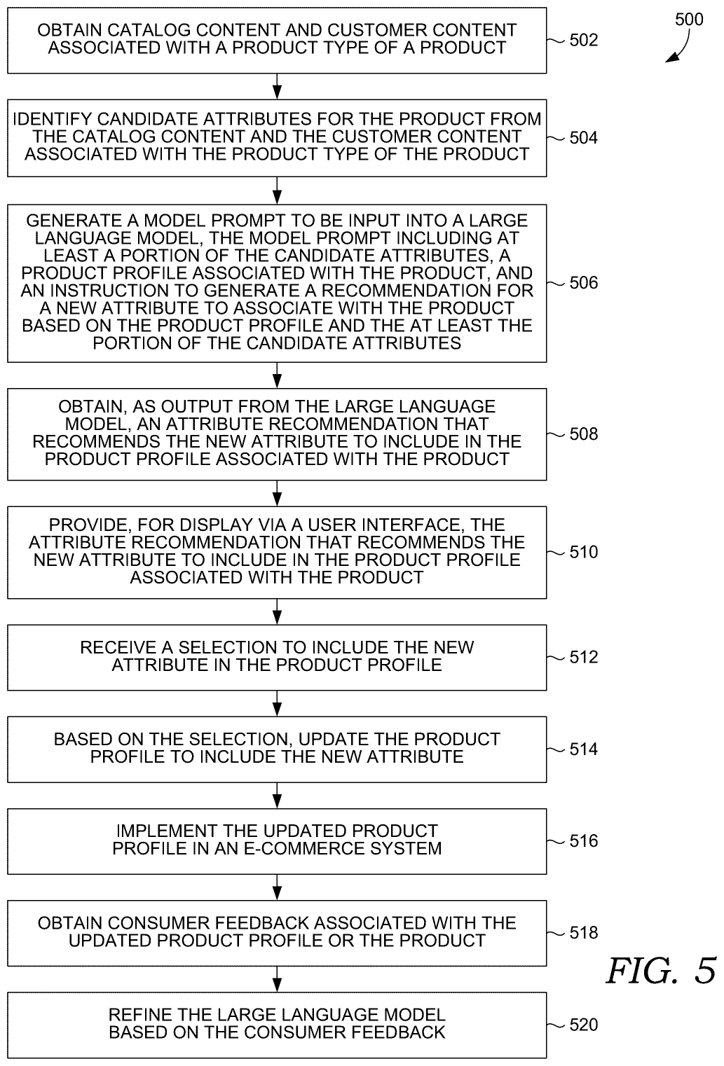

As described, various implementations can be used in accordance with embodiments described herein. FIGS. 5-7 provide methods of facilitating efficient product profile enhancement, in accordance with embodiments described herein. Methods 500, 600, and 700 can be performed by a computer device, such as device 800 described below. The flow diagrams represented in FIGS. 5-7 are intended to be exemplary in nature and not limiting.

Turning initially to method 500 of FIG. 5, method 500 is directed to facilitating efficient generation of product profile recommendations, in accordance with embodiments of the present technology. Initially, at block 502, catalog content and consumer content associated with a type of a product is obtained. Catalog content may include, for example, product purchase data, product comparison data, etc. Consumer content may include consumer reviews, product questions and answers, search queries, etc. In some cases, the product type of the product is identified using the product profile. For example, the product profile may include a feature indicating the product type or category associated with the product. At block 504, candidate attributes for the product are identified from the catalog content and the consumer content associated with the product type of the product. In some cases, candidate attributes are identified by extracting candidate attributes. For example NER and/or generative models may be used to extract candidate attributes from the catalog content and the consumer content.

At block 506, a model prompt to be input into a large language model is generated. In embodiments, the model prompt includes at least a portion of the candidate attributes, a product profile associated with the product, and an instruction to generate a recommendation for a new attribute to associate with the product based on the product profile and at least a portion of the candidate attributes. In some cases, the particular candidate attributes to be included in the model prompt may be selected based on relevance scores associated with the candidate attributes. For example, candidate attributes having a relevance score exceeding a threshold or a certain number of candidate attributes associated with the highest relevance scores may be selected for inclusion in the model prompt. The model prompt may include additional data, such as, for example, relevance scores associated with the candidate attributes, among other things. In embodiments, the LLM is fine-tuned using a dataset including product type and attribute pairs. Such fine-tuning enables a more industry-specific LLM.

At block 508, an attribute recommendation that recommends the new attribute to include in the product profile is obtained as output from the LLM. At block 510, the attribute recommendation that recommends the new attribute to include in the product profile is provided for display. For example, the attribute recommendation can be displayed to a merchandizer that manages content of product profiles. In some cases, the attribute recommendation is presented in association with, or concurrently with, the corresponding product profile.

At block 512, a selection to include the new attribute in the product profile is received. For instance, a user, such as a merchandizer, may select to include the new attribute in the product profile (e.g., by selecting a link, confirmation, approval, etc.). At block 514, the product profile is updated to include the new attribute. In this way, the product profile includes the previously existing attributes and the new attribute. At block 516, the updated product profile is implemented in an e-commerce system. In this regard, the updated product profile may be presented for display to consumers and/or used for performing searches for information or otherwise providing product information to consumers. At block 518, consumer feedback associated with the updated product profile or the product is obtained. In embodiments, consumer feedback includes clicks, views, add-to-cart, purchases, conversions, etc. At block 520, the large language model is refined based on the consumer feedback. In this way, the LLM is updated to align with consumer interests such that subsequently generated features correspond to the user interests.

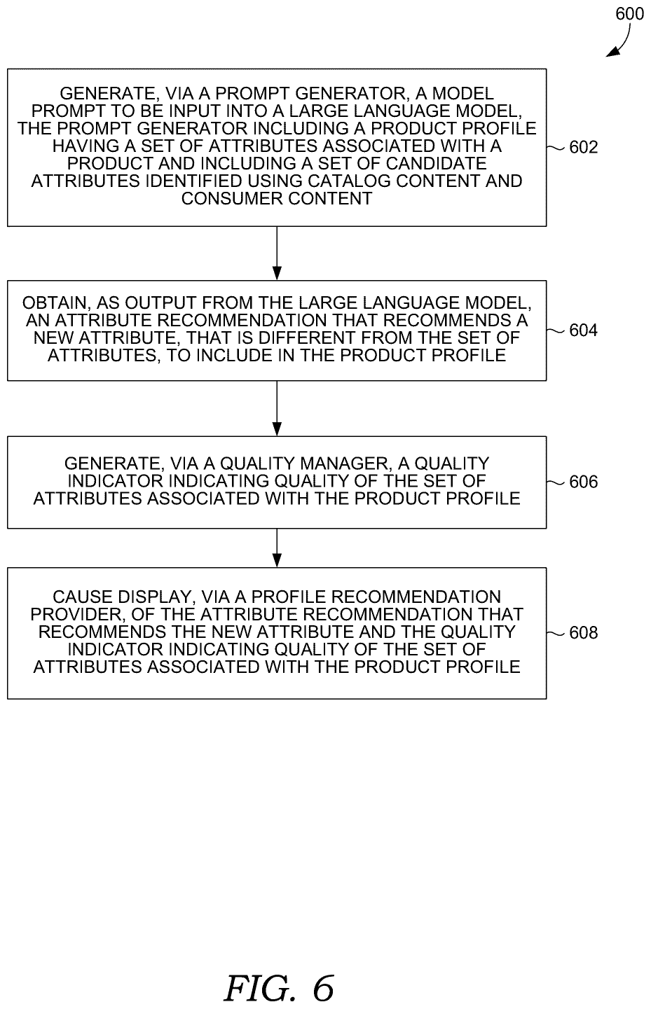

With reference to method 600 of FIG. 6, method 600 is directed to facilitating efficient generation of product profile recommendations and product profile quality indicators, in accordance with embodiments of the present technology. Initially, at block 602, a model prompt is generated to be input into an LLM. In embodiments, the model prompt includes a product profile having a set of attributes associated with a product and including a set of candidate attributes identified using catalog content and consumer content. At block 604, an attribute recommendation that recommends a new attribute, different from the set of attributes, to include in the product profile is obtained as output from the LLM. At block 606, a quality indicator indicating quality of the set of attributes associated with the product profile is generated. In some embodiments, the quality indicator is generated using a model-based text evaluation for entropy that compares the new attribute with the set of attributes existing in the product profile. Additionally or alternatively, the quality indicator is generated using a rule-based approach. Such rules can be provided by the merchandizer to align with specific interests. At block 608, the attribute recommendation and the quality indicator are provided for display. For example, a product profile monitoring assistant may be used to present the attribute recommendation and the quality indicator to a user in association with the corresponding product profile. In some cases, the user interface enables the user to provide feedback or input, for instance, to modify the attribute recommendation, and to select the attribute recommendation for incorporation into the product profile, among other things.

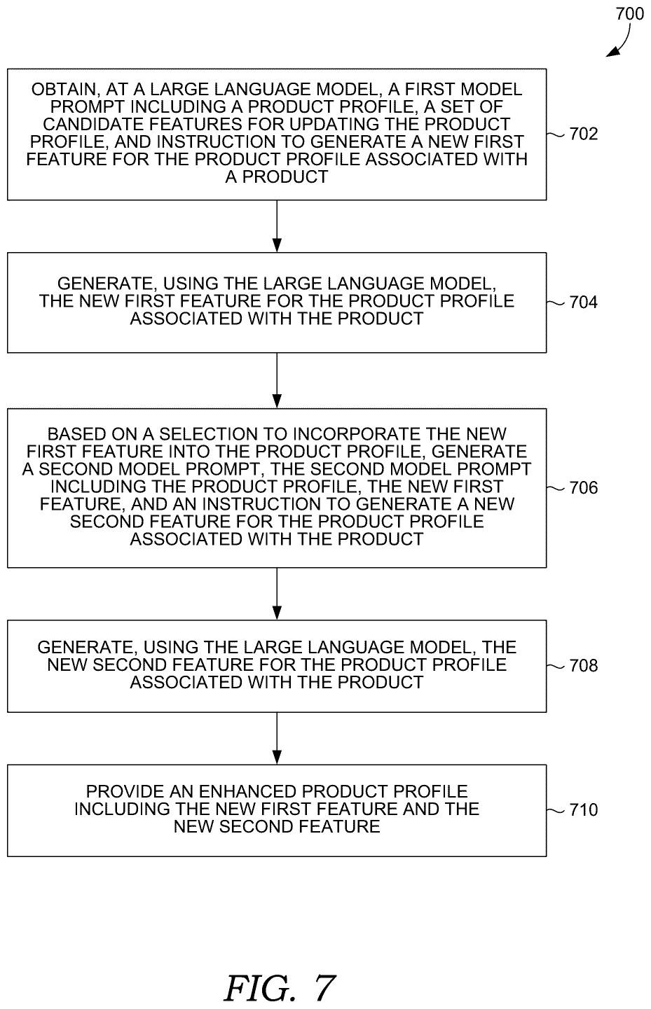

Turning now to method 700 of FIG. 7, method 700 is directed to facilitating efficient generation of product profile recommendations for different features, in accordance with embodiments described herein. Initially, at block 702, a first model prompt is obtained at an LLM. In embodiments, the first model prompt includes a product profile, a set of candidate features for updating the product profile, and instructions to generate a new first feature for the product profile associated with a product. For example, the first model prompt may request a new attribute for the product profile. At block 704, the new first feature for the product profile associated with the product is generated using the LLM. In some embodiments, the LLM is fine-tuned using a dataset including product-type and attribute pairs. Additionally or alternatively, the LLM is fine-tuned using consumer impressions, or other consumer interactions, associated with the product.

At block 706, a second model prompt is generated based on a selection to incorporate the new first feature into the product profile. In embodiments, the second model prompt includes the product profile, the new first feature, and an instruction to generate a new second feature for the product profile associated with the product. In some cases, the second new feature is a product description or a product name for the product. At block 708, the new second feature for the product profile associated with the product is generated using the LLM. At block 710, an enhanced product profile including the new first feature and the new second feature is provided. In this way, the enhanced product profile includes new features that improve the quality of the product profile.

Accordingly, we have described various aspects of technology directed to systems, methods, and graphical user interfaces for intelligently generating and providing product profile recommendations and/or product profile quality indicators. It is understood that various features, subcombinations, and modifications of the embodiments described herein are of utility and may be employed in other embodiments without reference to other features or subcombinations. Moreover, the order and sequences of steps shown in the example methods 500, 600, and 700 are not meant to limit the scope of the present disclosure in any way, and in fact, the steps may occur in a variety of different sequences within embodiments hereof. Such variations and combinations thereof are also contemplated to be within the scope of embodiments of this disclosure.

### Overview of Exemplary Operating Environment

Having briefly described an overview of aspects of the technology described herein, an exemplary operating environment in which aspects of the technology described herein may be implemented is described below in order to provide a general context for various aspects of the technology described herein.

Referring to the drawings in general, and to FIG. 8 in particular, an exemplary operating environment for implementing aspects of the technology described herein is shown and designated generally as computing device 800. Computing device 800 is just one example of a suitable computing environment and is not intended to suggest any limitation as to the scope of use or functionality of the technology described herein, and nor should the computing device 800 be interpreted as having any dependency or requirement relating to any one or combination of components illustrated.

The technology described herein may be described in the general context of computer code or machine-usable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Aspects of the technology described herein may be practiced in a variety of system configurations, including handheld devices, consumer electronics, general-purpose computers, and specialty computing devices. Aspects of the technology described herein may also be practiced in distributed computing environments where tasks are performed by remote-processing devices that are linked through a communications network.

With continued reference to FIG. 8, computing device 800 includes a bus 810 that directly or indirectly couples the following devices: memory 812, one or more processors 814, one or more presentation components 816, input/output (I/O) ports 818, I/O components 820, an illustrative power supply 822, and a radio(s) 824. Bus 810 represents what may be one or more buses (such as an address bus, data bus, or combination thereof). Although the various blocks of FIG. 8 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventor hereof recognizes that such is the nature of the art, and reiterate that the diagram of FIG. 8 is merely illustrative of an exemplary computing device that can be used in connection with one or more aspects of the technology described herein. Distinction is not made between such categories as “workstation,” “server,” “laptop,” and “handheld device,” as all are contemplated within the scope of FIG. 8 and refer to “computer” or “computing device.”

Computing device 800 typically includes a variety of computer-readable media. Computer-readable media can be any available media that can be accessed by computing device 800 and includes both volatile and non-volatile, removable and non-removable media. By way of example, and not limitation, computer-readable media may comprise computer storage media and communication media. Computer storage media includes both volatile and non-volatile, removable and non-removable media implemented in any method or technology for storage of information such as computer-readable instructions, data structures, program sub-modules, or other data.

Computer storage media includes RAM, ROM, EEPROM, flash memory or other memory technology, CD-ROM, digital versatile disks (DVDs) or other optical disk storage, magnetic cassettes, magnetic tape, magnetic disk storage, or other magnetic storage devices. Computer storage media does not comprise a propagated data signal.

Communication media typically embodies computer-readable instructions, data structures, program sub-modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 812 includes computer storage media in the form of volatile and/or non-volatile memory. The memory 812 may be removable, non-removable, or a combination thereof. Exemplary memory includes solid-state memory, hard drives, and optical-disc drives. Computing device 800 includes one or more processors 814 that read data from various entities such as bus 810, memory 812, or I/O components 820. Presentation component(s) 816 present data indications to a user or other device. Exemplary presentation components 816 include a display device, speaker, printing component, and vibrating component. I/O port(s) 818 allow computing device 800 to be logically coupled to other devices including I/O components 820, some of which may be built-in.

Illustrative I/O components include a microphone, joystick, game pad, satellite dish, scanner, printer, display device, wireless device, a controller (such as a keyboard and a mouse), a natural user interface (NUI) (such as touch interaction, pen [or stylus] gesture, and gaze detection), and the like. In aspects, a pen digitizer (not shown) and accompanying input instrument (also not shown but which may include, by way of example only, a pen or a stylus) are provided in order to digitally capture freehand user input. The connection between the pen digitizer and processor(s) 814 may be direct or via a coupling utilizing a serial port, parallel port, and/or other interface and/or system bus known in the art. Furthermore, the digitizer input component may be a component separated from an output component such as a display device, or in some aspects, the usable input area of a digitizer may be coextensive with the display area of a display device, integrated with the display device, or may exist as a separate device overlaying or otherwise appended to a display device. Any and all such variations, and any combination thereof, are contemplated to be within the scope of aspects of the technology described herein.

An NUI processes air gestures, voice, or other physiological inputs generated by a user. Appropriate NUI inputs may be interpreted as ink strokes for presentation in association with the computing device 800. These requests may be transmitted to the appropriate network element for further processing. An NUI implements any combination of speech recognition, touch and stylus recognition, facial recognition, biometric recognition, gesture recognition both on screen and adjacent to the screen, air gestures, head and eye tracking, and touch recognition associated with displays on the computing device 800. The computing device 800 may be equipped with depth cameras, such as stereoscopic camera systems, infrared camera systems, RGB camera systems, and combinations of these, for gesture detection and recognition. Additionally, the computing device 800 may be equipped with accelerometers or gyroscopes that enable detection of motion. The output of the accelerometers or gyroscopes may be provided to the display of the computing device 800 to render immersive augmented reality or virtual reality.

A computing device may include radio(s) 824. The radio 824 transmits and receives radio communications. The computing device may be a wireless terminal adapted to receive communications and media over various wireless networks. Computing device 800 may communicate via wireless protocols, such as code-division multiple access (“CDMA”), Global System for Mobiles (“GSM”), or time-division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection. A long-range connection may include a connection using one or more of CDMA, GPRS, GSM, TDMA, and 802.16 protocols.

The technology described herein has been described in relation to particular aspects, which are intended in all respects to be illustrative rather than restrictive.

What is claimed is:

1. A computing system comprising:
a processor; and
computer storage memory having computer-executable instructions stored thereon which, when executed by the processor, configure the computing system to perform operations comprising:
obtain catalog content and customer content associated with a product type of a product;
identify candidate attributes for the product from the catalog content and the consumer content associated with the product type of the product;
generate a model prompt to be input into a large language model, the model prompt including at least a portion of the candidate attributes, a product profile associated with the product, and an instruction to generate a recommendation for a new attribute to associate with the product based on the product profile and the at least the portion of the candidate attributes;
obtain, as output from the large language model, an attribute recommendation that recommends the new attribute to include in the product profile associated with the product; and
provide, for display via a user interface, the attribute recommendation that recommends the new attribute to include in the product profile associated with the product.

2. The computing system of claim 1, wherein the product type is identified via the product profile for the product.

3. The computing system of claim 1, wherein the candidate attributes are identified by extracting the candidate attributes using a named entity recognition model, a generative model, or a combination thereof.

4. The computing system of claim 1 further comprising selecting the at least the portion of the candidate attributes, from among the candidate attributes, based on relevance scores associated with the candidate attributes.

5. The computing system of claim 1, wherein the model prompt further includes relevance scores associated with the at least the portion of the candidate attributes.

6. The computing system of claim 1, wherein the large language model is fine-tuned using a dataset including product type and attribute pairs.

7. The computing system of claim 1, wherein the product profile includes a set of attributes and one or more of a product title, a product description, and the product type.

8. The computing system of claim 1 further comprising:
receiving a selection to include the new attribute in the product profile; and
based on the selection, updating the product profile to include the new attribute.

9. The computing system of claim 1 further comprising:
implementing the updated product profile in an e-commerce system;
obtaining consumer feedback associated with the updated product profile or the product; and
refining the large language model based on the consumer feedback.

10. The computing system of claim 1 further comprising using the attribute recommendation to generate a quality indicator associated with the product profile.

11. The computing system of claim 10, wherein the quality indicator is generated using a rule-based analysis.

12. The computing system of claim 10, wherein the quality indicator is generated using a model-based analysis including comparing the new attribute to existing attributes in the product profile.

13. A computer-implemented method comprising:
generating, via a prompt generator, a model prompt to be input into a large language model, the prompt generator including a product profile having a set of attributes associated with a product and including a set of candidate attributes identified using catalog content and consumer content;
obtaining, as output from the large language model, an attribute recommendation that recommends a new attribute, that is different from the set of attributes, to include in the product profile;
generating, via a quality manager, a quality indicator indicating quality of the set of attributes associated with the product profile; and
causing display, via a profile recommendation provider, of the attribute recommendation that recommends the new attribute and the quality indicator indicating quality of the set of attributes associated with the product profile.

14. The computer-implemented method of claim 13, wherein the quality indicator is generated using a model-based text evaluation for entropy that compares the new attribute with the set of attributes existing in the product profile.

15. The method of claim 13, wherein the model prompt further includes at least one of:
an instruction to generate the new attribute given the product profile and the set of candidate attributes; and
a set of relevance cores associated with the set of candidate attributes.

16. The method of claim 13, wherein the set of candidate attributes included in the model prompt are identified by:
extracting candidate attributes from the catalog content and the consumer content;
generating relevance scores for each of the candidate attributes; and
selecting the set of candidate attributes, from the extracted candidate attributes, based on the relevance scores.

17. The method of claim 13 further comprising:
receiving a selection to incorporate the new attribute into the product profile;
based on the selection, generating a new model prompt to be input into the large language model to generate an updated description for the product profile or an updated title for the product profile;
obtaining, as output from the large language model, a recommendation for the updated description for the product profile or the updated title for the product profile; and
causing display of the recommendation for the updated description for the product profile or the updated title for the product profile.

18. One or more computer storage media having computer-executable instructions embodied thereon that, when executed by one or more processors, cause the one or more processors to perform a method, the method comprising:
obtaining, at a large language model, a first model prompt including a product profile, a set of candidate features for updating the product profile, and instruction to generate a new first feature for the product profile associated with a product;
generating, using the large language model, the new first feature for the product profile associated with the product;
based on a selection to incorporate the new first feature into the product profile, generating a second model prompt, the second model prompt including the product profile, the new first feature, and an instruction to generate a new second feature for the product profile associated with the product;
generating, using the large language model, the new second feature for the product profile associated with the product; and
providing an enhanced product profile including the new first feature and the new second feature.

19. The media of claim 18, wherein the first new feature comprises an attribute for the product profile and the second new features comprises a product description or a product name for the product profile.

20. The media of claim 18, wherein the large language model is fine-tuned using at least one of product-type and attribute pairs and consumer impressions associated with the product.
